(19) United States
(12) Patent Application Publication
(10) Pub. No.: US 2008/0083487 A1
(43) Pub. Date: Apr. 10, 2008

(54) Automatic tape dispenser

(75) Inventors: Craig Moss, Westport, CT (US); Paul Dowd, Bronxville, NY (US); Robert J. Victor, Long Island, NY (US); Norman L. Barrigas, Danbury, CT (US); Michael Hymes, Bronxville, NY (US)

Correspondence Address: GRIMES & BATTERSBY, LLP, 488 MAIN AVENUE, THIRD FLOOR, NORWALK, CT, 06851, US

(73) Assignee: Global Access Corporation

(21) Appl. No.: 11/543,474

(22) Filed: Oct. 5, 2006

(51) Int. Cl. B32B 37/00

(52) U.S. Cl. 156/250; 156/577; 156/510

(57) ABSTRACT

An automatic tape dispenser for automatically dispensing and cutting a length of adhesive tape or other spooled material having adhesive on one or both sides stored on a roll by a user operating the dispenser single-handedly is provided, the dispenser comprising a housing including a cylindrical post for loading and receiving the roll of tape, at least one drive wheel for advancing the roll of tape, means for preventing the tape from jamming, and means for safely cutting the tape comprising a pair of scissor-like blades disposed at the opening of the housing through which the tape is dispensed.

### BACKGROUND OF THE INVENTION

1. Field of the Invention

The present invention relates generally to an improved device for dispensing adhesive tape, and more particularly to such a device for automatically dispensing adhesive tape or other similar materials stored on a roll, and even more particularly to such a device including means for advancing, dispensing and cutting said adhesive tape using one hand.

2. Description of the Prior Art

Tape or adhesive dispensers of various forms have long been known in the art. The most common examples of such dispensers comprise plastic disposable hand-held dispensers and desktop dispensers. Automatic dispensers and “tape guns” of the type having a spindle upon which a roll of tape is attached, at least one roller and guide for rolling out the tape, and a handle or grip for holding the dispenser are also known, although less common. Such dispensers are designed to allow a user to dispense a length of tape relatively automatically using one hand by affixing the start of the tape to an object, using the adhesion of the tape to the object to unspool the desired length of tape, then cutting the tape by biasing a saw-like cutter against the tape.

Such devices are relatively simple to operate in principle, although in practice managing the tape and cutting it at the desired length is quite difficult, often resulting in the tape folding upon itself or adhering to the object in an undesired location or position, or even damaging the object. Furthermore, such dispensers have traditionally been used for rolls of tape having large diameters and widths, and not for smaller rolls of tape. An example of such device is shown in U.S. Pat. No. 6,540,002, which issued to Edwards, et al. on Apr. 1, 2003 for “Apparatus for dispensing mesh drywall tape,” which patent discloses a mesh drywall tape dispensing apparatus including a chassis with a pistol grip for one-hand operation, a tape reel, a tape guide roller mounted within the chassis, and a tape pressure roller mounted adjacent a front end of the chassis.

Smaller hand-held devices capable of housing smaller rolls of tape have also been developed. For example, U.S. Pat. No. 3,725,182, which issued to Regan on Apr. 3, 1973 for “Tape dispenser” discloses a hand-held dispenser including a tape guide adjacent a cutting edge for enabling the application of tape with the guide being movable to move the tape against the cutting edge after dispensing.

Alternative means for cutting the tape are also known in the prior art. For example, U.S. Pat. No. 4,630,765, which issued to Samuelson, et al. on Dec. 23, 1986 for “Dispenser for tape with a stretchable backing,” discloses a tape dispenser for pressure sensitive adhesive coated tape having a stretchable backing including a housing comprising having a cover defining a socket adapted to receive a portion of a user's thumb so that the user may grasp the dispenser in one hand with his fingers around the base and his thumb in the socket and with one hand alone move the cover and base between their open and closed positions leaving his other hand free to pull tape from the dispenser. Similarly, U.S. Pat. No. 4,826,557, which issued to Fu, et al. on May 2, 1989 for “Tape dispenser” discloses an improved tape dispenser having a gun-shaped housing and operated by a trigger in operative association with a number of interconnected links so that a cutting blade disposed at the gun point can be actuated to laterally move for cutting off the rolled tape and smoothly dispensing the same simultaneously. Another example of an automatic cutter is shown in U.S. Pat. No. 4,762,586, which issued to Wilkie on Aug. 9, 1988 for “Combination tape applicator and tape dispenser,” and which discloses a combined tape dispenser and hand-held tape applicator wherein tape is mounted on a tape carrier normally biased to an extended tape-applicating position and manually retractable to expose a normally guarded cutting blade for severing the tape, and further wherein the tape carrier is movable toward its retracted position either by a trigger adjacent a handgrip or by pivotal movement of the handgrip substantially to its retracted position.

It is also well-known in the art to provide means for automatically advancing the tape using a trigger or similar device. For example, U.S. Pat. No. 4,643,059, which issued to Phillips, et al. on Feb. 17, 1987 for “Tape dispenser” discloses a tape dispenser having a hollow body to receive a supply of medicated tape to be dispensed in predetermined lengths into the mouth of an animal, the tape dispenser being trigger operated and provided with a barrel along which a delivery head moves, whereby a predetermined length of tape is delivered into the barrel and severed from the supply by said delivery head, which predetermined length is then delivered into the mouth of the animal via the terminal end of the barrel. Another example of an automatic dispenser is shown in U.S. Pat. No. 5,910,227, which issued to Mistyurik, et al. on Jun. 8, 1999 for “Hand-held labeler” discloses a hand-held labeler having a gear driven print head wherein the print head is situated on an upper housing section and the print head is actuated from a lower housing section such that the upper housing section can be moved to an open position without interfering with the maintenance of the drive connection with the print head or the advance of a label carrying web through the labeler.

The combination of the automatic tape advancing feature and the automatic cutter is a relatively recent innovation. An example of an automatic tape dispenser including both features is shown in U.S. Pat. No. 6,065,519, which issued to Lee on May 23, 2000 for “Automatic drawing and cutting device for adhesive tape dispenser,” which discloses an adhesive tape dispenser including a case body for containing an adhesive tape and having a detachable cover, a drawing means for automatically drawing the adhesive tape from the case body in a desired length, and a cutting means for automatically cutting the adhesive tape drawn by the drawing means. Similarly, U.S. Pat. No. 6,176,409, which issued to Lee on Jan. 23, 2001 for “Adhesive tape dispenser” discloses an adhesive tape dispenser which includes a gun-shaped case body having a detachable cover, a drawing portion for drawing an adhesive tape from the case body, and a trigger handle protruded outwardly from one side of the case body and a pair of drums rotating with the trigger handle, and a cutting portion for cutting the adhesive tape which is drawn by the drawing portion from the dispenser, and having a handling member mounted on a gunbarrel portion of the case body, a lever interlocking with the handling member and a cutter mounted at a front end of the lever, so that an user may draw the adhesive tape as long as necessary by pulling the trigger handle without pulling it with hand, an adhesive strength of the adhesive tape is kept in good state, and an adhesion state of the adhesive tape is clean, since the adhesive tape is cut clean by a cutter.

Prior designs use sharpened knife blades to skewer and slice the tape. In order to function, these blades must be extremely sharp and pointed, which makes them very dangerous if they are exposed to the user in any way.

As shall be appreciated, the prior art fails to specifically address either the problem or the solution arrived upon by applicant.

### SUMMARY OF THE INVENTION

Against the foregoing background, it is a primary object of the present invention to provide an automatic tape dispenser that is operable with one hand.

It is another object of the present invention to provide such a tape dispenser that allows a user to easily and automatically apply any length of tape from a roll to an object.

It is but another object of the present invention to provide such a tape dispenser that allows a user to easily and automatically advance the tape to a desired length.

It is still another object of the present invention to provide such a tape dispenser that allows a user to easily and automatically cut the tape once the desired length is reached.

It is yet a further object of the present invention to provide such a tape dispenser that is easily loaded and unloaded.

It is yet another object of the present invention to provide such a tape dispenser that may be used with a variety of different types and lengths of tape.

It is a further object of the present invention to provide such a tape dispenser that is inexpensive to manufacture.

It is also an object of the present invention to provide such a tape dispenser that is easy to manufacture.

It is another object of the present invention to provide such a tape dispenser that cuts the tape in a fashion more analogous to a pair of scissors.

It is still another object of the present invention to provide such a tape dispenser that includes two metal cutting elements whose edges are not particularly sharp or pointed which can be exposed to the user with no danger.

It is a further object of the present invention to provide such a tape dispenser that may be used to dispense a wide variety of tapes having adhesive on one side, including clear tapes, masking tapes, surgical tapes, double-sided tape and the other materials that are stored in a roll on a spindle.

To the accomplishments of the foregoing objects and advantages, the present invention, in brief summary comprises an automatic tape dispenser for automatically dispensing and cutting a length of tape by a user operating the dispenser single-handedly, said dispenser comprising housing including a cylindrical post for loading and receiving the roll of tape, at least one drive wheel for advancing the roll of tape, means for preventing the tape from jamming, and means for safely cutting the tape comprising a pair of scissor-like blades disposed at the opening of the housing through which the tape is dispensed.

### BRIEF DESCRIPTION OF THE DRAWINGS

FIG. 1 is an exploded perspective view of a roll of tape and a simple housing for the automatic tape dispenser of the present invention;

FIG. 2 is an exploded perspective view of a roll of tape and another example of a simple housing for the automatic tape dispenser of the present invention;

FIG. 3 is an exploded perspective view of a roll of tape and yet another example of a simple housing for the automatic tape dispenser of the present invention;

FIG. 4 is an exploded perspective view of a roll of tape and still another example of a simple housing for the automatic tape dispenser of the present invention;

FIG. 5 is a perspective view of a roll of tape, drive wheels and guide post of the automatic tape dispenser of the present invention showing the direction of motion of the elements;

FIG. 6 is a simple side elevational view showing a portion of tape and the drive wheel of the automatic tape dispenser of the present invention;

FIG. 7 is a simple side elevational view showing the elements of FIG. 5 as well as center roller;

FIG. 8 is a partially-exploded perspective view of the automatic tape dispenser of the present invention;

FIG. 9 is an exploded perspective view of the trigger housing element of the automatic tape dispenser of the present invention;

FIGS. 10a-10d are perspective views showing the attachment of the trigger housing element to the cutter housing element;

FIG. 11 is a side elevational view of the trigger housing element of FIG. 9;

FIGS. 12a-12e are perspective views of the cutting elements of the automatic tape dispenser of the present invention showing the cutting path of the blades;

FIGS. 13a-13c are side elevational views showing the cutter lever sub-assembly;

FIGS. 14a-14b are side elevational and top plan views showing elements of the cutter lever sub-assembly;

FIG. 15 is an exploded perspective view showing elements of the cutter housing element;

FIG. 16 is a perspective view showing the cutter lever sub-assembly and roller;

FIGS. 17a and 17b are perspective views showing the cutter housing element in the open and closed positions;

FIGS. 18a and 18b are side elevational views showing the trigger housing elements with the trigger released and the trigger depressed; and

FIG. 19 is a cut-away perspective view showing the means for attaching the trigger housing element to the cutter housing element for the automatic tape dispenser of the present invention.

### DETAILED DESCRIPTION OF THE PREFERRED EMBODIMENTS

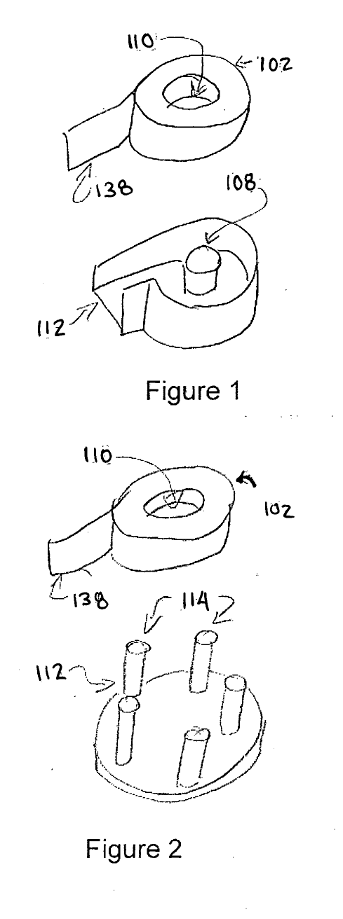

Referring to the drawings and, in particular, to FIG. 1 thereof, the automatic tape dispenser is provided and is referred to generally by reference numeral 10. The dispenser 10 comprises a housing 100 within which the roll of tape 102 is inserted and housed. In the preferred embodiment, the housing 100 comprises a pair of complementary housing elements 104 which cooperate to form a chamber 106 in the housing 100 within which the roll of tape 102 is stored. The housing has an “opened” and “closed” position, the former being used to insert or remove the roll of tape 102, the latter being used for the actual dispensing of the tape 102. In the preferred embodiment, opening and closing the housing 100 requires the user to bias the housing elements 104 relative to each other. The device 10 accepts a new roll of tape 102 by opening the housing 100 and inserting the roll of tape 102 onto a cylindrical post 108.

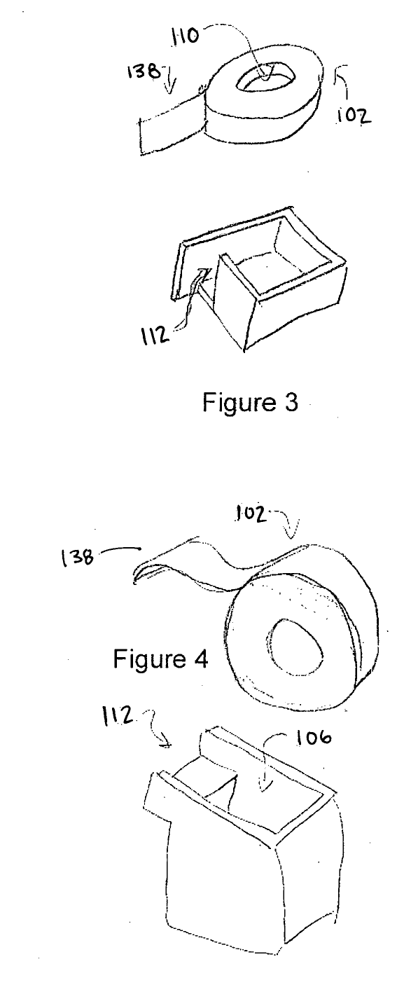

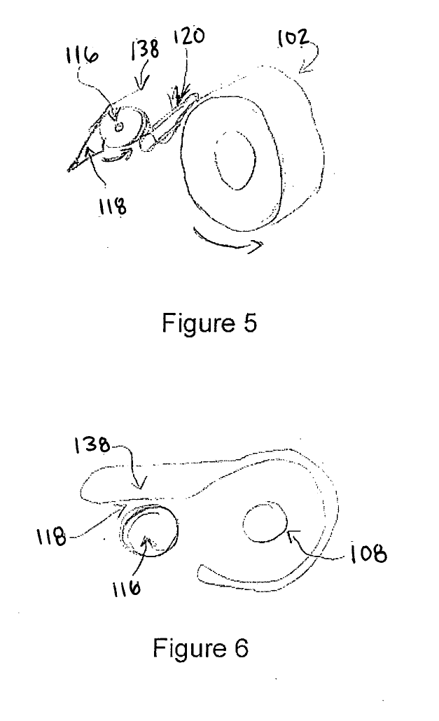

In the preferred embodiment, the roll of tape 102 is attached to the cylindrical post 108 in an axial direction, as shown in FIG. 1. However, in certain other embodiments, particularly those without axles such as those shown in FIGS. 2 and 3, it may be advantageous to have an opening in the side of the chamber 106 so that the user can install the tape 102 by moving it in a direction perpendicular to its axis, as is shown in FIG. 4.

The housing elements 104 may be removably attached to each other by various means, such as by frictional attachment or by means of snaps or the like. In the preferred embodiment, however, the housing elements 104 share a common axis as the cylindrical post 108, and the housing elements 104 are separated by first rotating the two housing elements 104 relative to each other about the cylindrical post 108 in a scissor-like motion, then by pulling the two elements 104 apart axially relative to the cylindrical post. The housing elements 104 are attached by reversing this process.

The cylindrical post 108 is sized so as to fit through the hole 110 in the roll of tape 102. It is also possible to locate the tape 102 by containing it within a chamber 106 that is somewhat larger than the tape 102 and has an opening 112 in one wall of the chamber 106 to allow the tape 102 to exit the chamber 106 (as shown in FIG. 1). This chamber 106 can be a substantially closed cylinder, but it need not be cylindrical (FIG. 3), or even mostly enclosed (FIG. 2) to function. For instance, a series of posts 114 could surround the roll of tape 102 and allow it to rotate, but still locate it well.

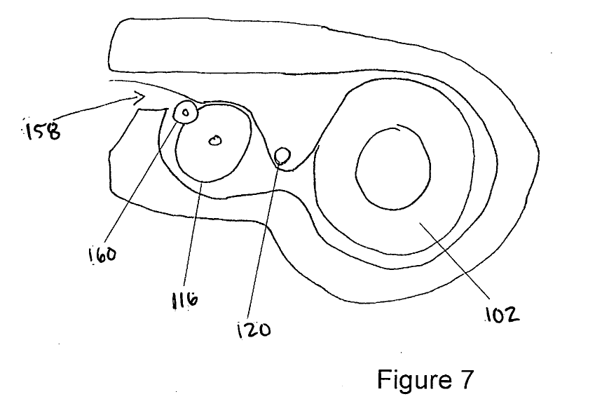

A pair of rotating wheels 116 is provided for advancing the tape 102. The adhesive side 118 of the tape 102 sticks to the outside surfaces of the wheels 116, and as the wheels 116 turn they serve to pull more tape 102 off the roll and into adhesion with themselves. A guide post 120 is disposed within the housing 100 to encourage the adhesion of the tape 102 to the wheels 116 (as shown in FIG. 7). The guide post 120 serves to pull the tape 102 down from its natural path to the rotating wheels 116, therefore increasing the area of attachment between the tape 102 and the rotating wheels 116. Flex arm 122 is also provided to force the tape 102 into contact with the wheels 116 when tape 102 is installed. It should be appreciated that flex arm 122 can serve the same function as guide post 120, thereby rendering the guide post 120 superfluous.

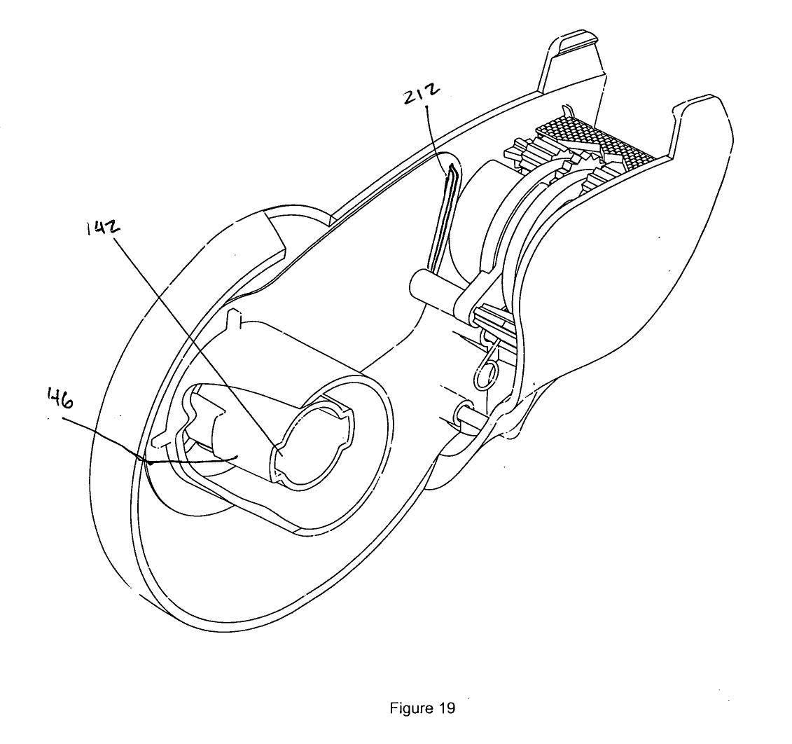

The wheels 116 are rotated by means of a user-operated trigger 124 interconnected with said wheels 116. The trigger 124 is pulled back by the user to drive the wheels 116. The trigger 124 moves within a fixed angle of travel (as shown in FIGS. 18a & 18b), and is returned to its original position by means of a torsion spring 126 which is located on a shaft 128 integral to the trigger 124 and coaxial with the wheels 116 and the trigger 124 rotation. This torsion spring 126 acts between the trigger 124 and mounting bracket 130.

Rotation of the wheels 16 is provided by means of the interaction between a ratchet pawl 132 connected to the trigger 124 and the corresponding inwardly facing ratchet teeth 134 on each wheel 116. A second ratchet pawl 136, connected to the bracket 130 mounting the wheel 116/trigger 124 assembly to the housing 100 of the device 10, also engages the ratchet teeth 134 in the wheels 116. The ratchet pawl 132 on the trigger 124 serves to rotate the top surface of the wheel 116 forwards, advancing the tape 102, and the second ratchet pawl 136 on the housing serves to prevent the wheel 116 from rotating backwards and thereby pulling the tape 102 back and potentially jamming the device 10.

In the preferred embodiment, the ratchet pawls 132, 136 are plastic features integrally molded onto other parts. In the case of the trigger pawl 132, it is molded as one piece with the trigger 124. The housing pawl 136 would similarly be integrally molded into the bracket 130. The ratchet pawls 132, 136 are shaped and manufactured from a material that allows them to flex but also have an elastic restorative force to keep them in contact with the ratchet teeth 134 to properly work as ratchets. By integrating the ratchet pawls 132, 136, the preferred embodiment has fewer parts and can be manufactured more economically than existing designs.

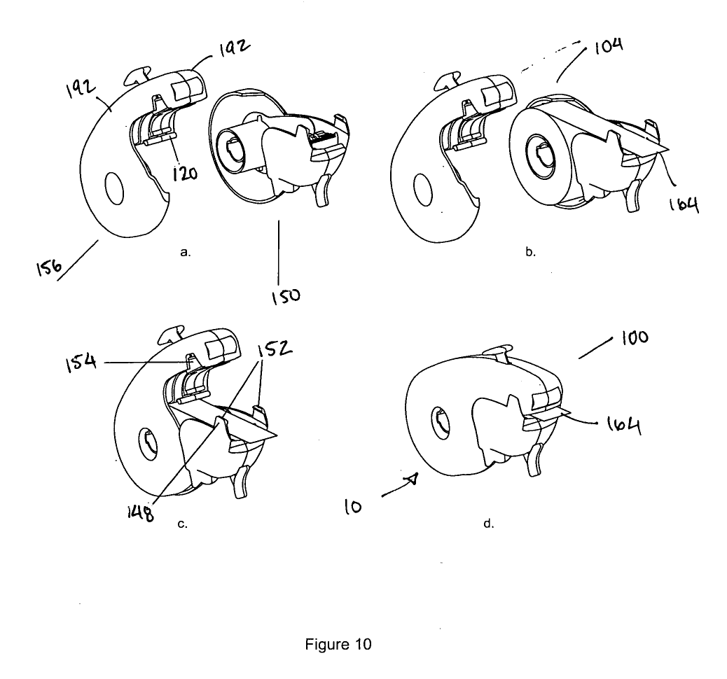

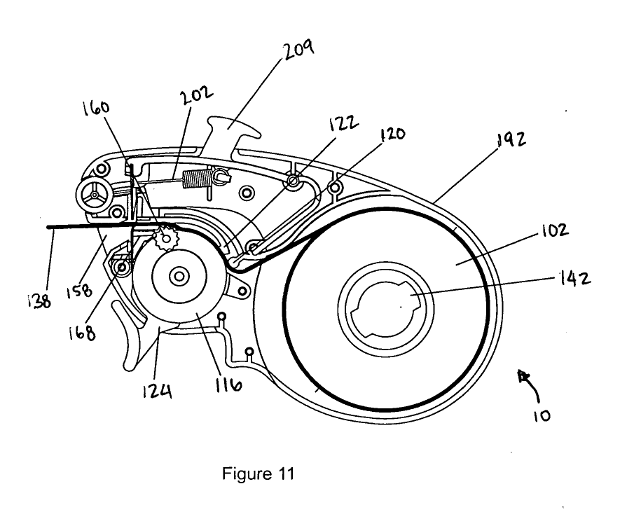

After the roll of tape 102 is inserted into the device 10, a length of tape 138 must be separated from the roll 102 and placed across the wheels 116 in order for the wheels 116 to operate properly and advance the tape 102. The tape 102 can be placed directly on the wheels 116 by pulling out a length of tape 138 and dragging it across the wheels 116, in much the same was as 35 mm film is loaded onto the take up wheels of a camera (as shown in FIGS. 10a through 10d). As discussed, the length of tape 138 is forced to take on a serpentine shape (as shown in FIGS. 7 and 11) in order to exit the roll 102, bend backwards around the post 120 and then curve the opposite way to go around the wheels 116. In the preferred design, the housing element 104 upon which the post 120 is mounted is first translated axially relative to the roll of tape 102 previously placed on the housing element 104 holding the wheels 116, and then rotated into its final position (as shown in FIGS. 10a through 10d).

A female keying feature 140 on one housing element 104 accepts a mating male keying feature 142 on the other housing element 104 to ensure that the two housing element 104 halves can only be inserted together in such an orientation that ensures the tape 102 will not be struck during the axial movement. The fact that the male keying feature 142 is elongated prevents the rotation of the housing 104 until the axial movement is complete. Once rotated, a pair of edges 144 on the female keying feature 140 tuck under the bumps 146 of the male keying features 142 to prevent axial movement. A pair of ears 148 on the trigger housing 150 includes small undercuts 152 which engage matched recesses 154 in the cutter housing 156 to provide a detent fit to keep the housings 104 from rotating relative to each other.

Once the tape 102 has been loaded, started, and advanced, it must detach from the wheels 116 and exit the housing 100 so it can be used. The challenge then becomes to strip the tape 102 from the wheels 116 and transport it to the exit orifice 158 of the housing 100 without getting it hung up or stuck to something. The wheels 116 provides the motive force for moving the tape 102 and any resistance to the movement of the tape 102 that occurs after the wheels 116 will put the tape 102 into compression. Many types of tape 102 are very prone to buckling, and cannot tolerate the compression forces developed when the sticky side of the tape 102 adheres to a surface. Actually stripping the tape 102 from the wheels 116 is accomplished by locating a pair of small rollers 160 on either side of each drive wheels 116. A center roller 162 is also disposed between the two wheels 116 (while the small rollers 160 are located just to the outside of each wheels 116).

The perimeters of the rollers 160, 162 extend beyond the perimeters of the drive wheels 116 (as shown in FIG. 11), which tends to push the tape 102 off the drive wheels 116. It is important that the rollers be located close to the surfaces on the drive wheels 116 to which the tape 102 is so as to be most effective at breaking the adhesive bond between the tape 102 and the drive wheels 116. It has been observed that if they are too far away, the lack of stiffness in the tape 102 would result in the tape 102 merely bending instead of releasing from the drive wheels 116.

Another important factor is the extent to which the rollers extend beyond the perimeter of the drive wheels 116, and the radial position on the perimeter of the drive wheels 116 where they do so. The goal is to get the tape 102 to release from the drive wheels 116, and then stay high so the non sticky side of the tape 102 encounters the boundaries of the exit orifice 158 and the sticky side of the tape 102 does not touch anything. FIG. 11 illustrates the tape end 164 situated high up against the top limit of the exit orifice 158 in the optimal position for the tape 102 to move. Another factor found to help manage the disposition of the tape 102 as it comes off the wheels 116 is to make the center roller 162 extend further beyond the perimeter of the wheels 116 than the outer rollers 160.

In the preferred embodiment, the rollers 160, 162 are made of a non-adhering material such as silicone. Teeth 166 are provided on the perimeter of the rollers 160, 162 to reduce the surface area of contact with the tape 102 and thereby further reduce the adhesive force. As a precaution against the sticky side of the tape 102 getting caught on something, the preferred design further includes a silicone spike pad 168 with a bed of spikes 170 located just after the wheels 116. The spikes 170 serve to reduce the contact area possible for the tape 102. This spike pad 168 acts as a backup method of avoiding buckling of the tape 102 due to adhesion after it is stripped from the wheels 116. If tape 102 does make its way down to that area despite the effects of the rollers 160, 162, then the spike pad 168 will help prevent adhesion. Another reason for the spike pad 168 is that it can help pop the tape after a cut. The tips of the spikes 170 are actually a bit higher than the lower blade cutting edge, so the tape 102 is forced down onto the front row of spikes 170 during a cut. The spring back of the spikes 170 and tape 102 helps pop it off the lower blade. It has been observed that if the cut edge of the tape 102 remains stuck to the lower blade cutting edge in any way it can lead to a jam.

Two notches 172 may be provided in the spike pad 168 just ahead of the adhesion surfaces of the wheels 116. It has been observed that with certain soft and sticky tapes, removing material from this area helped prevent tape hang ups. It has also been observed that with the soft and sticky tape, the tape 102 can be more difficult to strip from the wheels 116 and the tape 102 can be pulled down between the stripper rollers 160, 162 creating dents in the tape 102 which would dip down low enough and contact the silicone spike pad 168 with sufficient force to cause the tape 102 to hang up. Removing the material from the notches 172 allows more room for the tape to dip without adverse effects.

In the preferred embodiment, the tape is cut by means of a pair of cutting blades 174, 176 disposed in such a way as to create a scissor-type cutting action that is much safer than existing designs using sharpened blades. In fact, in the preferred design, the cutting blades 174, 176 are made from thin sheet metal that has been stamped or laser cut with no secondary sharpening required. The included angle of the cutting edge is roughly 90 degrees and presents a fairly blunt edge to the user.

In order to operate effectively, such a scissor cutting approach demands precise alignment of the blades 174, 176, as well as a certain amount of force to keep the blades 174, 176 in contact during cutting. One blade 174 must be made to pass across the other 176 in a progressive fashion such that point contact is maintained between the linear cutting edges throughout the movement. A conventional pair of scissors uses a fixed pivot between the two cutting blades. The current design demands a solution where the two cutting blades 174, 176 can be completely removed from each other to load tape 102 into the device 10 and to allow tape 102 to dispense, but then be aligned for a cut.

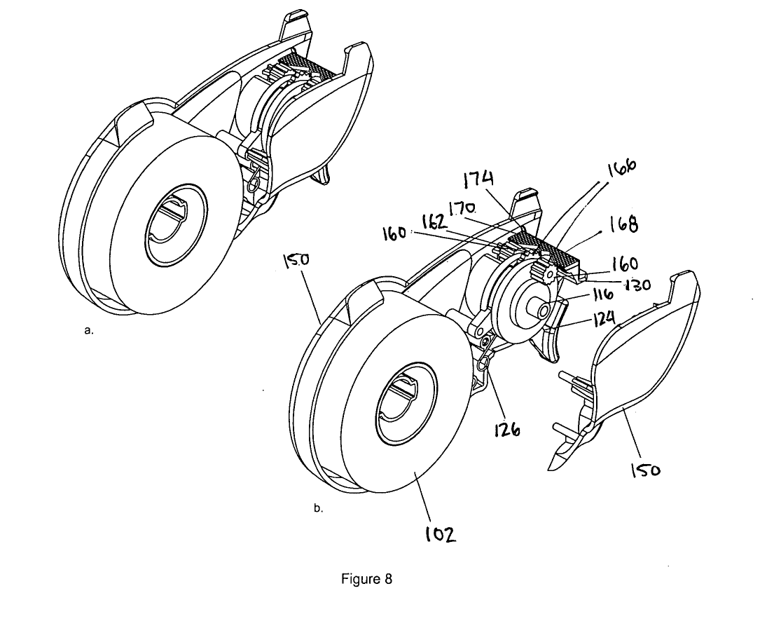

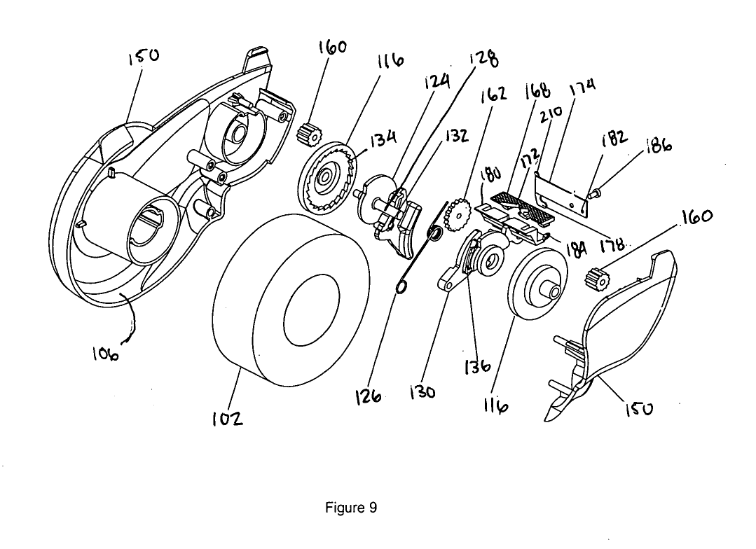

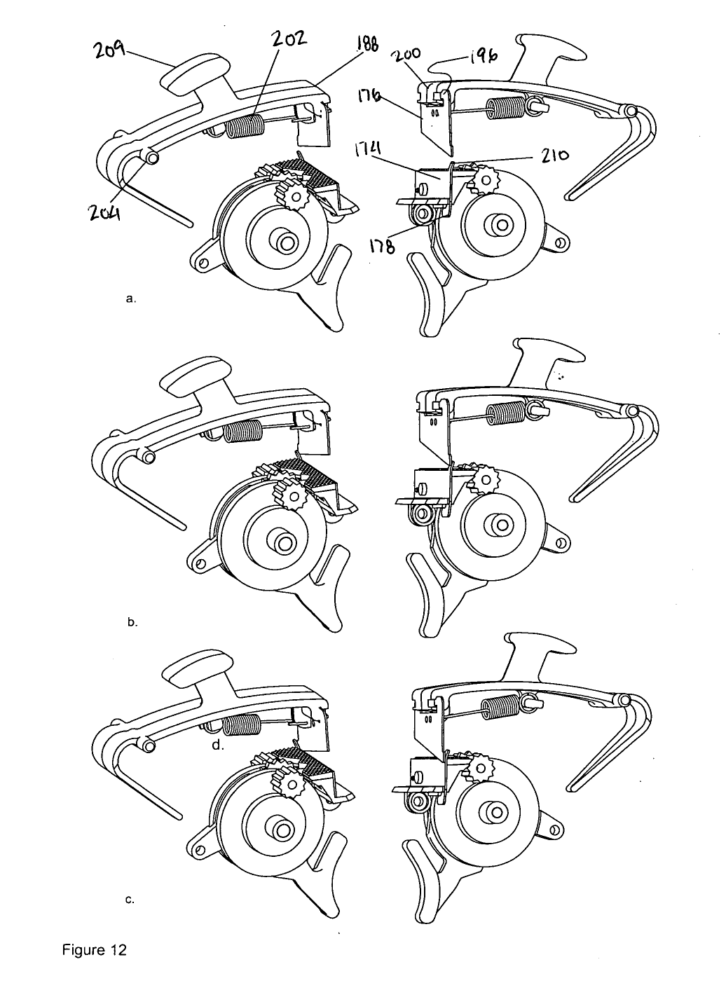

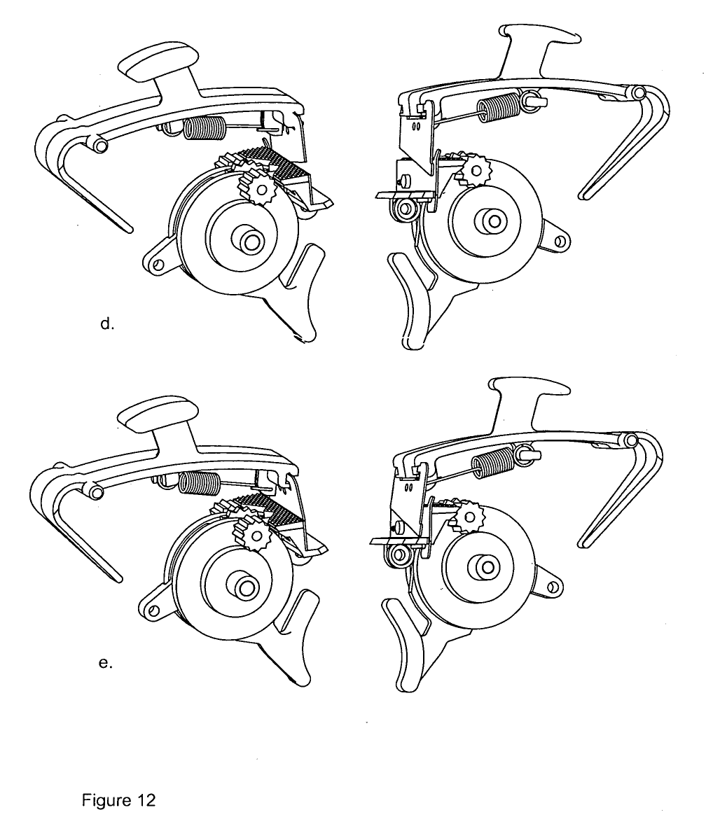

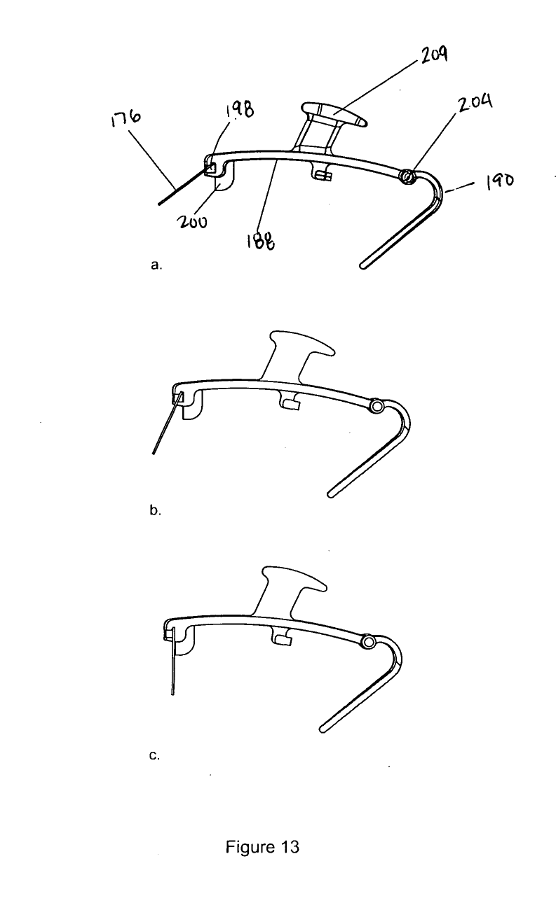

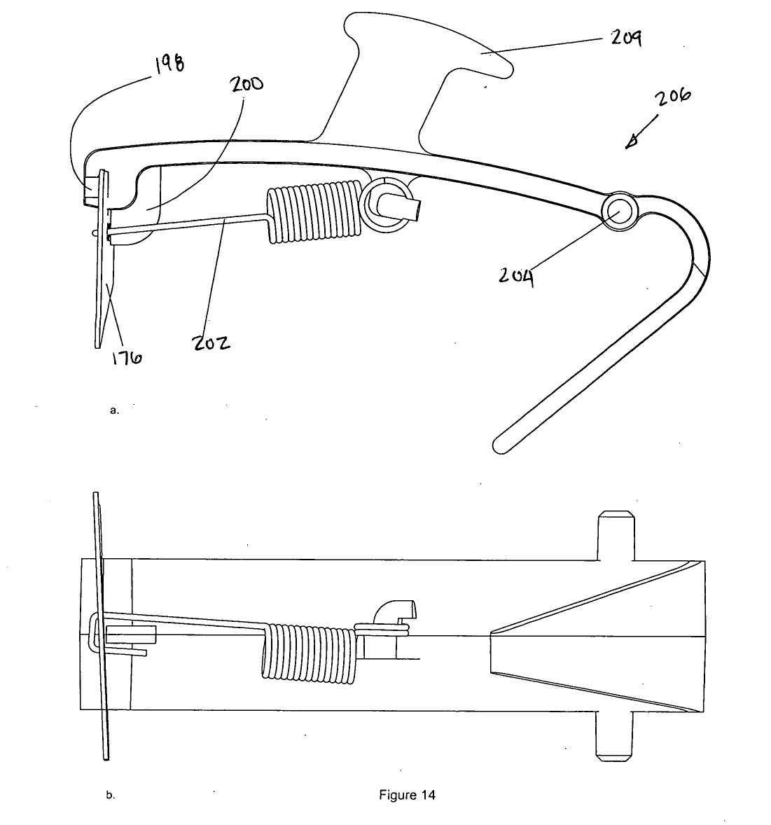

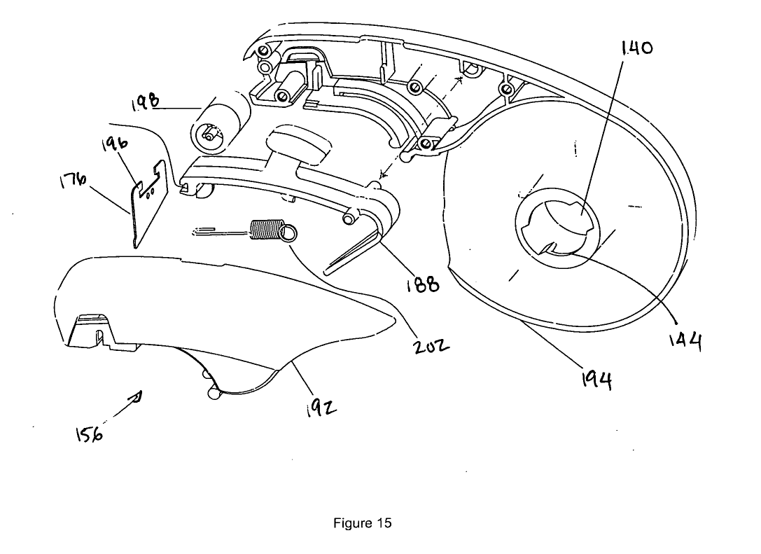

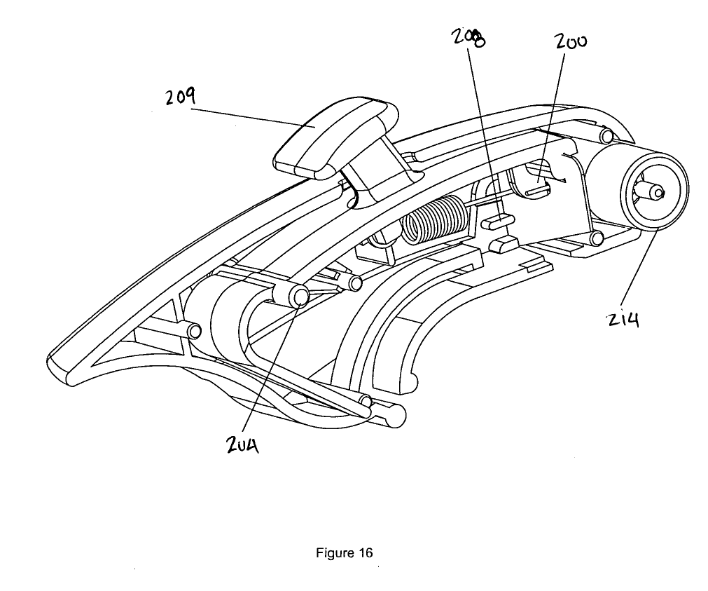

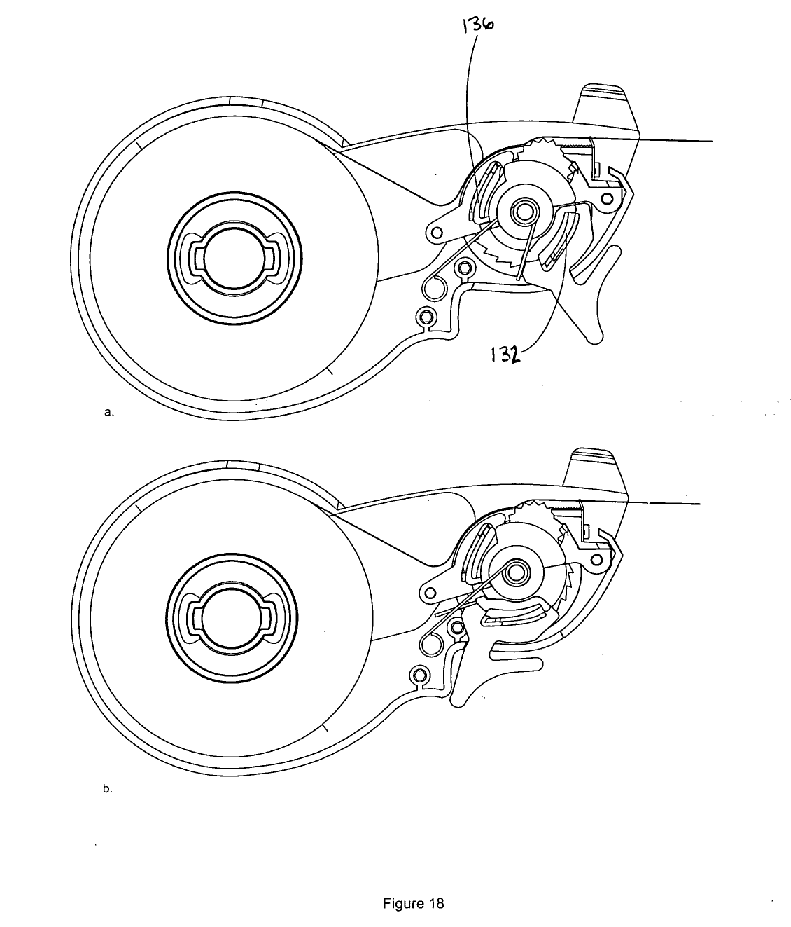

The proper cutting motion at the blade interface is created by holding the blades 174, 176 independently, yet still achieving the precise alignment and force application required for a good cut. The lower blade 174 is held fixed relative to the trigger housing assembly 150 depicted in FIGS. 8a and 9. The blade 174 is located by a hook feature 178 which engages a slot 180 in the mounting bracket 130, and a hole 182 in the blade 174 locates on a corresponding pin 184 molded into the bracket. A screw 186 fixes the lower blade 174 to the bracket 130. The upper blade 176 is mounted to a cutting lever 188. The cutting lever 188 pivots at one end on a shaft feature 190 which engages the cutter housings 192, 194 of the device 10, and the other end of the lever 188 holds the upper blade 176. The upper blade 176 is held in place by ears 196 on the blade 176 which engage pockets 198 in the lever 188 which are formed in such a way that, referring to FIG. 13, the blade 176 can be inserted perpendicular to its final position (FIG. 13a), such that when rotated to its final position (FIGS. 13b & 13c) it is held securely. For assembly purposes a positive stop 200 located on the lever 188 holds the upper blade 176 in place against the force of a spring 202. In this fashion, the blade location is stabilized prior to mounting this sub-assembly into the cutter housings 192, 194 (as shown in FIGS. 15 and 17). The pockets 198 in the lever 188 which accept the ears 196 on the blade 176 are staggered, so that one is further from the axis of the pivot axle 204 of the lever 188 than the other. This forces the blade 176 into the angled orientation (see FIG. 14b) that is required in order to engage the lower blade 176 in point contact during cutting (as shown in FIGS. 12a-12e).

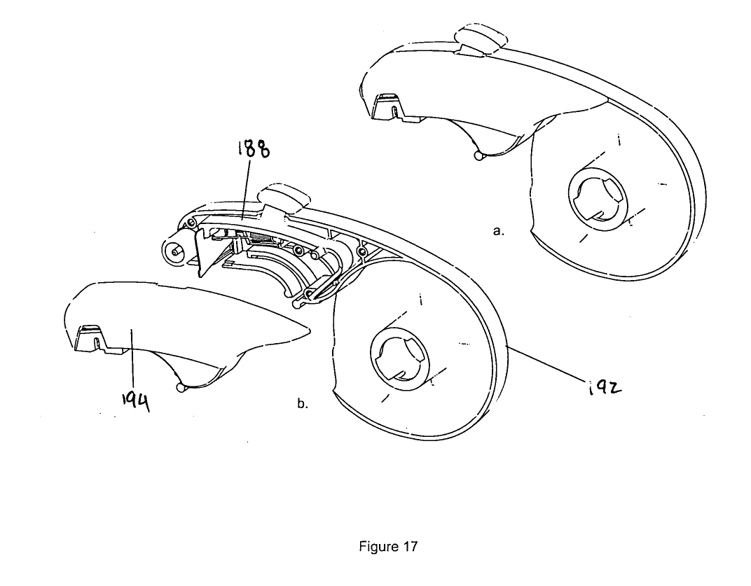

The cutter lever subassembly 206 (shown in FIG. 14) comprising the cutter housings 192, 194 and cutting parts is installed into the cutter housing element 156 (as shown in FIGS. 16 & 17), a positive stop 208 in the front cutter housing 192 supersedes the positive stop 200 on the lever 188 in determining the limit of motion (in a direction towards the lever pivot 204 of the upper blade 176. This carefully placed stop 208 ensures that the leading tip of the upper blade 176 will contact the sloped surface of the lead-in tab on the lower blade 174. This is the “parked” position for the upper blade, and it leaves ample room for tape 102 to be dispensed between the blades. FIG. 12b shows the leading tip of the upper blade 176 as it makes contact with the lead-in tab 210 of the lower blade 174. The purpose of the lead-in tab 210 is to allow for the inevitable misalignment between the upper and lower blades 174, 176. The lead-in ramp 210 “catches” the leading tip/cutting edge of the upper blade 174 and guides it towards the cutting edge of the lower blade 176. It supersedes the stop 208 as the feature that determines the position of the upper blade 176. Once past the lead-in ramp, the upper blade's cutting edge begins to run across the cutting edge of the lower blade 176 (as shown in FIG. 12c), starting the cut. Now the point contact between the cutting edges of the upper and lower blades 174, 176 determines the position of the upper blade 176. All the while, the tension spring 202 prevents the upper blade 176 from moving any further away from the pivot 204 than it must. As the upper blade 176 moves past the lower blade 174 (as shown in FIG. 12d) the upper blade 176 rotates forward, stretching the tension spring 202. This action ensures a constant pressure at the point of contact between the upper and lower blades 174, 176, leading to a clean cut. FIG. 12c depicts the end of the cutting motion in a full cut. Operation of the cutter lever sub-assembly 206 is effected by depressing the cutter button 209. It has been observed that the operation of the cutter button 209 by depressing the button 209 is far more efficient and ergonomic than a slide-type cutter mechanism.

It has further been observed that the tape 102 can jam on the lower cutter blade 174 if the tape is allowed to drift left and right in its path, particularly depending on how the user holds the device 10. In the preferred embodiment, therefore, ribs 212 are provided on each side of the tape path to center the tape 102. These ribs 212 are disposed just before the drive wheels 116, as it has been found that putting the ribs 212 after the drive wheels 116 results in the ribs 212 acting as obstacles to the motion of the tape 102, potentially causing a jam. It is at this point before the drive wheels 116 that the tape 102 is under tension, as opposed to after the drive wheels where the tape is being pushed or compressed. In the preferred embodiment, these ribs 212 comprise a pair of raised protrusions on either side of the tape path.

It should be appreciated that instead of dispensing short individual pieces of tape 102, the dispenser 10 of the present invention can also be used much like a tape gun commonly used to dispense packing tape. The ratchets 132 on the wheels 116 don't prevent the tape 102 from being pulled out. As illustrated in FIG. 16, a cylindrical roller 212 with an axle shaft that is located by bosses in the housings 192, 194 is situated on the front of the device 10 just above where the tape 102 exits. If one advances a certain amount of tape 102, the tape end 164 can be adhered to the object to be taped by pressing and rolling the roller 212 in such a manner that it pushes the tape 102 into the object. Moving the device 10 while keeping it pressed down to the object can serve to reel out more tape 102. The blades 174, 176 still operates normally in this application.

Having thus described the invention with particular reference to the preferred forms thereof, it will be obvious that various changes and modifications can be made therein without departing from the spirit and scope of the present invention as defined by the appended claims.

What is claimed is:

1. A device for automatically and single-handedly dispensing adhesive tape or other spooled material having adhesive on one or both sides from a roll of the type having a centrally located core, said device comprising:
a pair of housing elements for loading and receiving said core, said housing elements comprising a lower trigger housing and an upper cutter housing;
means for advancing said roll of tape;
means for preventing said tape from binding, buckling or jamming; and
means for safely cutting said tape, said means comprising a lower blade mounted on said lower trigger housing and an upper blade mounted within said upper cutter housing.

2. The device of claim 1, wherein said roll of tape includes a hole therethrough, and wherein said lower trigger housing includes a post adapted to be inserted through said hole.

3. The device of claim 1, wherein said upper cutter housing is pivotally and removably attachable to said lower trigger housing by means of complementary interlocking cylindrical components.

4. The device of claim 3, wherein said complementary interlocking cylindrical components comprise a first and second cylindrical components, wherein said first cylindrical component include means for slidably engaging with said second cylindrical component and preventing rotation of said lower trigger housing and said upper cutter housing until said first cylindrical component is completely attached to said second cylindrical component.

5. The device of claim 4, wherein said means for slidably engaging comprises at least one raised shoulder on said first cylindrical component and a complementary channel on said second cylindrical component.

6. The device of claim 1, wherein means for advancing said roll of tape is housed within said trigger housing.

7. The device of claim 6, wherein said roll of tape includes a leading edge and wherein said lower trigger housing is separable from said upper cutter housing for loading said roll of tape into said lower trigger housing by separating said leading edge from said roll and stretching said leading edge to a point external to said device.

8. The device of claim 7, wherein said upper cutter housing is pivotally and removably attachable to said lower trigger housing and wherein said upper cutter housing and said lower trigger housing have an open and a closed position.

9. The device of claim 8, wherein said upper cutter housing includes a flexible arm which serves to guide said tape against said means for advancing when said device is in said closed position.

10. The device of claim 1, wherein said means for advancing comprises at least one drive wheel, and a trigger and ratchet pawl connected to said at least one drive wheel.

11. The device of claim 10, further including a bracket including a second integrally molded ratchet pawl, and wherein said trigger and ratchet pawl are integrally molded as one piece.

12. The device of claim 11, further including a set of ratchet teeth disposed on said drive wheel, wherein said ratchet pawls are configured to engage said ratchet teeth and rotate said drive wheel in one direction and prevent rotation in a direction opposite said one direction.

13. The device of claim 12, wherein said means for advancing further comprises at least one roller disposed along the perimeter of said drive wheel for separating said tape from said drive wheel.

14. The device of claim 1, wherein said means for preventing said tape from binding, buckling or jamming comprises a silicone spike pad, wherein said spike pad is disposed immediately behind said lower blade and wherein spikes disposed on said spike pad are raised slightly above said lower blade.

15. The device of claim 1, wherein said means for preventing said tape from binding, buckling or jamming comprises at least one pair of guide ribs disposed between said roll of tape and said means for advancing for preventing excessive lateral movement of said tape.

16. The device of claim 1, wherein said upper blade is mounted to a movable cutter lever.

17. The device of claim 16, further including a cutter button attached to said cutter lever to thereby operate said cutter lever and force said upper blade against said lower blade.

18. The device of claim 17, wherein at least one of said upper blade and said lower blade is mounted by means of a flexible hinge.

19. The device of claim 18, wherein said blade attached by means of a flexible hinge further includes a blade stop disposed behind said blade and further including tension means attached to said cutter to bias said blade against said blade stop while allowing said blade to pivot forward relative to said hinge.

20. The device of claim 19, wherein said lower blade includes an upper blade guide positioned to engage said upper blade during cutting to ensure said upper blade passes in front of said lower blade in a shearing motion to cut said tape.

21. The device of claim 20, wherein said lower blade and said upper blade are disposed at a slight angle relative to each other so as to initiate point contact between said blades during contact.

22. A device for automatically and single-handedly dispensing adhesive tape or other spooled material having adhesive on one or both sides from a roll of the type having a centrally located core, said tape including a leading edge thereto, said device comprising:
a pair of housing elements for loading and receiving said core, said housing elements comprising a lower trigger housing and an upper cutter housing, wherein said upper cutter housing is pivotally and removably attachable to said lower trigger housing by means of complementary interlocking cylindrical components;
means for advancing said roll of tape housed within said trigger housing, wherein said lower trigger housing is separable from said upper cutter housing for loading said roll of tape into said lower trigger housing by separating said leading edge from said roll and stretching said leading edge to a point external to said device, further wherein said means for advancing comprises at least one drive wheel and at least one trigger connected to said at least one drive wheel;
means for preventing said tape from binding, buckling or jamming, wherein said means for preventing said tape from binding, buckling or jamming comprises a silicone spike pad, wherein said spike pad is disposed immediately behind said lower blade and wherein spikes disposed on said spike pad are raised slightly above said lower blade, and wherein said means for preventing said tape from binding, buckling or jamming further comprises at least one pair of guide ribs disposed between said roll of tape and said means for advancing for preventing excessive lateral movement of said tape; and
means for safely cutting said tape, said means comprising a lower blade mounted on said lower trigger housing and an upper blade mounted within said upper cutter housing, wherein said upper blade is mounted by means of a hinge to a movable cutter lever and further wherein said cutter lever includes a blade stop disposed behind said upper blade and further including tension means attached to said upper blade and said cutter lever to bias said upper blade against said blade stop while allowing said upper blade to pivot forward about said hinge.

23. A method for automatically and single-handedly dispensing adhesive tape or other spooled material having adhesive on one or both sides from a roll of the type having a centrally located core, said method comprising:
providing a dispensing apparatus comprising:
a pair of housing elements for loading and receiving said core, said housing elements comprising a lower trigger housing and an upper cutter housing;
means for advancing said roll of tape;
means for preventing said tape from binding, buckling or jamming; and
means for safely cutting said tape, said means comprising a lower blade mounted on said lower trigger housing and an upper blade mounted within said upper cutter housing;
separating said housing elements;
securing said roll of tape within said trigger housing;
separating a leading end of said tape from said roll;
stretching said leading edge across said means for advancing to a point external to said device;
slidably engaging said cutter housing to said trigger housing and rotating said cutter and trigger housings relative to each other to close said housing elements;
advancing said end of tape by depressing said trigger repeatedly until a desired length of tape is dispensed; and
cutting said length of tape by depressing said cutter button to bias said upper cutter against said lower cutter.
